(19) United States
(12) Patent Application Publication
(10) Pub. No.: US 2012/0261066 A1
(43) Pub. Date: Oct. 18, 2012

(54) Sealed Device and Method of Sealing

(75) Inventors: Kevin W. Smith, Coral Gables, FL (US); Derek Dee Deville, Coral Gables, FL (US); Carlos Rivera, Cooper City, FL (US); Michael Walter Kirk, Miami, FL (US); Thomas O. Bales, JR., Coral Gables, FL (US); Matthew A. Palmer, Miami, FL (US)

(73) Assignee: COVIDIEN AG, Neuhausen am Rheinfall (CH)

(21) Appl. No.: 13/445,752

(22) Filed: Apr. 12, 2012

Related U.S. Application Data
(60) Provisional application No. 61/476,048, filed on Apr. 15, 2011.

(51) Int. Cl. B32B 37/12

(52) U.S. Cl. 156/275.5

(57) ABSTRACT

A method for creating a sealed device includes the steps of providing a structure comprised of at least two adjacent parts forming an enclosure and having a contact surface therebetween. At least one part of the structure is comprised of a material that appears substantially opaque to the naked eye and is substantially transparent to light. A light-curable adhesive is applied at the contact surface, and light is transmitted to cure the light-curable adhesive to form a hermetic seal at the contact surface between the at least two adjacent parts.

### CROSS-REFERENCE TO RELATED APPLICATIONS

This application claims priority, under 35 U.S.C. §119, of U.S. Provisional Patent Application Ser. No. 61/476,048, filed on Apr. 15, 2011, the entire disclosure of which is hereby incorporated by reference in its entirety.

### FIELD OF THE INVENTION

The present invention lies in the field of sealing. The present disclosure relates to a sealed enclosure device and method of sealing that uses a light curable adhesive to attach enclosure parts together.

### BACKGROUND OF THE INVENTION

Devices having a mechanical housing or enclosure are typically formed from two or more parts attached together to enclose therein mechanical or electrical components that allow the device to function. Various examples of different ways of attaching multi-part enclosures include:
using any combination of adhesives and mechanical attachment mechanisms, e.g., o-rings, tabs, latches, bolts;
forming an interference fit between parts, e.g., using friction between two parts to seal the parts together; and
welding parts together.

One particular example (disclosed in U.S. Provisional Patent Application Ser. Nos. 61/376,983, filed on Aug. 25, 2010, and 61/476,022, filed on Apr. 15, 2011, hereby incorporated by reference in their entireties) uses ultrasonic welding to attach two housing sub-parts together. In this example, two halves of a battery assembly outer shell of a surgical device are ultrasonically welded together to provide a hermetic seal between the components within the battery assembly and the environment. The hermetic seal sufficiently isolates the interior of the battery assembly and the components disposed therein from a sterile field of an operating environment into which the device has been introduced so that no contaminants from one side of the seal are able to transfer to the other side of the seal. This seal is at least gas-tight, thereby preventing intrusion of air, water, vapor phase H₂O₂, etc. This gas-tight construction of the battery assembly allows it to be sterilized, for example, using low-temperature vapor phase Hydrogen Peroxide (H₂O₂) as performed by the sterilization devices manufactured by the Steris Corporation and referred to under the trade name V-PRO or manufactured by Advanced Sterilization Products (ASP), division of Ethicon, Inc., a Johnson & Johnson company, and referred to under the trade name STERRAD®.

Although the hermetic seal formed by the ultrasonic welding of the battery assembly described above advantageously allows sterilization of the battery assembly, maintenance of the hermetic seal, and thus preservation of the components housed within the battery assembly, could decrease over time. The combination of H₂O₂, cleaning chemicals, and disinfecting solution, all used during sterilization, puts stress on the hermetic seal and, therefore, the components within the battery assembly as well.

Thus, a need exists to overcome any potential for problems with the systems, designs, and processes as discussed above.

### SUMMARY OF THE INVENTION

The invention provides a sealed device and method of sealing that overcome the hereinafore-mentioned disadvantages of the heretofore-known devices and methods of this general type.

With the foregoing and other objects in view, there is provided, in accordance with the invention, a method for creating a seal, including the steps of providing a structure comprised of at least two adjacent parts forming an enclosure and having a contact surface therebetween, at least one part of the structure being comprised of a material that appears substantially opaque to the naked eye and is substantially transparent to light, applying a light-curable adhesive at the contact surface, and transmitting light to cure the light-curable adhesive to form a hermetic seal at the contact surface between the at least two adjacent parts.

With the objects of the invention in view, there is also provided a method for creating a seal including the steps of providing a structure comprised of at least first and second housing portions having first and second contact surfaces, respectively and a band comprised of a material that is substantially transparent to light, the band being disposed between the first and second housing portions at the first and second contact surfaces to form an enclosure together with the first and second housing portions, applying a light-curable adhesive at the first and second contact surfaces between the band and the first and second housing portions, and transmitting light to cure the light-curable adhesive to form a hermetic seal at the first and second contact surfaces between the band and the first and second housing portions.

With the objects of the invention in view, there is also provided a method for creating a seal, including the steps of providing a multi-part structure comprised of adjacent parts that form an enclosure and have a contact surface therebetween, disposing at least one light source inside the enclosure, applying a light-curable adhesive at the contact surface, and powering the at least one light source to transmit light sufficient to cure the light-curable adhesive from inside the enclosure and, thereby, form a hermetic seal at the contact surface between the adjacent parts.

In accordance with another mode of the invention, the light cures the light-curable adhesive by being transmitted through the at least one part of the structure that is both substantially opaque to the naked eye and substantially transparent to light.

In accordance with a further mode of the invention, the at least one part of the structure that is both substantially opaque to the naked eye and substantially transparent to light is transparent to ultraviolet light, the light-curable adhesive is curable by ultraviolet light, and the transmitted light is ultraviolet light.

In accordance with an added mode of the invention, the at least one part of the structure that is both substantially opaque to the naked eye and substantially transparent to light is transparent to visible light, the light-curable adhesive is curable by visible light, and the transmitted light is visible light.

In accordance with an additional mode of the invention, the at least one part of the structure that is both substantially opaque to the naked eye and substantially transparent to light is comprised of a transparent polymeric material.

In accordance with yet another mode of the invention, there is provided the step of adding at least one of a light-transmissive agent to the transparent polymeric material to cause the transparent polymeric material to have an opaque appearance to the naked eye and a diffusing agent to the transparent polymeric material to disperse the transmitted light along the contact surface for curing the light-curable adhesive.

In accordance with yet a further mode of the invention, after the applying step and before the transmitting step, forming a closed enclosure by placing the at least two adjacent parts of the structure together at the contact surface.

In accordance with yet an added mode of the invention, the structure further comprises a band comprised of a material that is substantially transparent to light, the band being disposed between the at least first and second housing portions at the contact surface to form an enclosure together with the first and second housing portions.

In accordance with yet an additional mode of the invention, the light cures the light-curable adhesive by being transmitted through the band.

In accordance with again another mode of the invention, the band is transparent to ultraviolet light, the light-curable adhesive is curable by ultraviolet light, and the transmitted light is ultraviolet light.

In accordance with again a further mode of the invention, the band is transparent to visible light, the light-curable adhesive is curable by visible light, and the transmitted light is visible light.

In accordance with again an added mode of the invention, the band appears substantially opaque to the naked eye.

In accordance with again an additional mode of the invention, there is provided the step of adding at least one of a light-transmissive agent to the band to cause it to have an opaque appearance to the naked eye and a diffusing agent to the band to disperse the transmitted light along the at least one contact surface for curing the light-curable adhesive.

In accordance with still another mode of the invention, there are provided the steps of providing a battery assembly inside the enclosure and electrically coupling the battery assembly to the at least one light source for powering the at least one light source.

In accordance with still a further mode of the invention, a circuit board is provided within the enclosure and the at least one light source is disposed on the circuit board, the circuit board being operable to cause the at least one light source to transmit the light sufficient to cure the light-curable adhesive.

In accordance with still an added mode of the invention, the at least one light source is at least one ultraviolet light source and the light-curable adhesive is curable by ultraviolet light. The at least one light source is a plurality of ultraviolet light-emitting diodes.

In accordance with still an additional mode of the invention, the at least one light source is at least one visible light source and the light-curable adhesive is curable by visible light.

Although the invention is illustrated and described herein as embodied in a sealed device and method of sealing, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a fragmentary, left side elevational view of a surgical device having a battery assembly according to an exemplary embodiment of the invention;

FIG. 2 is a perspective view from above the front of the battery assembly of FIG. 1;

FIG. 3 is a fragmentary, perspective view of a battery assembly sealed in accordance with an exemplary embodiment of the present invention;

FIG. 4 is fragmentary, perspective view of a battery assembly sealed in accordance with another exemplary embodiment of the present invention;

FIG. 5 is a fragmentary perspective view of an exemplary embodiment of internal components within the battery assembly of FIG. 2;

FIG. 6 is a side perspective view of a transducer-and-generator assembly of the device of FIG. 1; and

FIG. 7 is a side perspective view of another exemplary embodiment of a transducer-and-generator assembly in accordance with the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

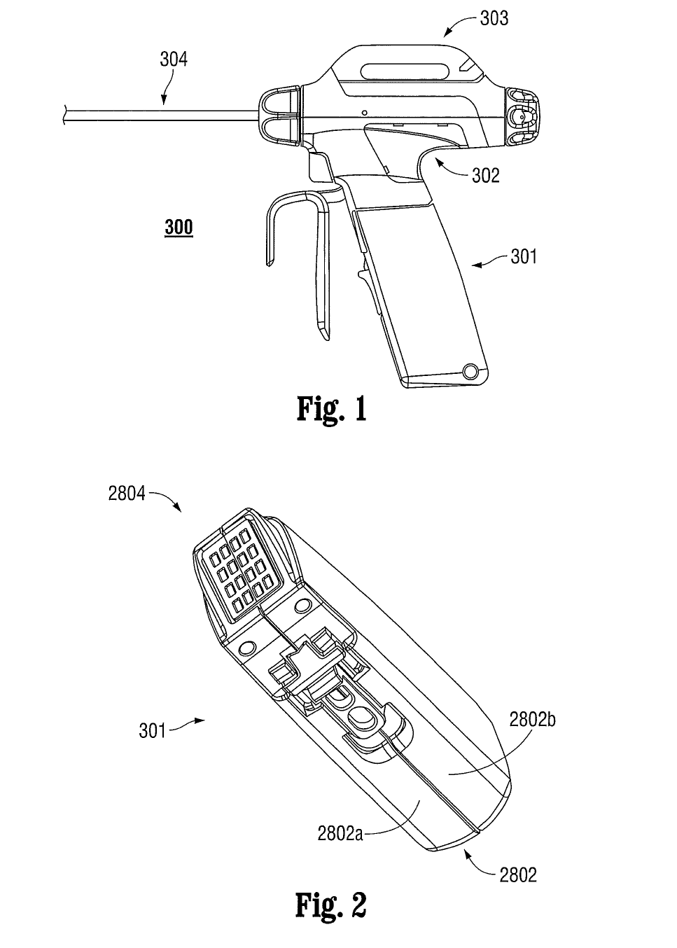

Referring now to the figures of the drawings in detail and first, particularly to FIG. 1, there is shown a first exemplary embodiment of a cordless surgical assembly 300, which is described in detail in U.S. Provisional Patent Application Ser. Nos. 61/376,983 and 61/476,022. The assembly 300 includes three main component parts: (1) a battery assembly 301; (2) a handle assembly 302 with an ultrasonic-cutting-blade-and-waveguide assembly 304; and (3) a transducer-and-generator (“TAG”) assembly 303.

FIG. 2 shows the fully assembled battery assembly 301, which has been ultrasonically welded so that the two halves 2802a and 2802b of the outer shell 2802, as well as the potted multi-lead battery terminal assembly 2804, provide a hermetic seal between the environment and the interior of the battery assembly 301. Exemplary embodiments of the present invention provide inventive methods for sealing multi-part housings of similar battery and TAG assemblies. However, it is to be understood that the disclosed embodiments are merely exemplary of the invention, which can be embodied in various devices having a mechanical housing or enclosure formed from two or more parts attached together to enclose therein various mechanical or electrical components. Some exemplary devices include laparoscopic cameras, rigid endoscopes, and other enclosure devices or devices that are not necessarily enclosure devices, e.g., laparoscopic or other mechanical hand tools.

A “hermetic” seal, as used herein, indicates a seal that sufficiently isolates a compartment (e.g., an interior of a shell) and components disposed therein from a sterile field of an operating environment into which the device has been introduced so that no contaminants from one side of the seal are able to transfer to the other side of the seal. This seal is at least gas-tight, thereby preventing intrusion of air, water, vapor phase H₂O₂, etc. Upon initial assembly, room air will be trapped in the enclosure with whatever moisture is present. This can easily be more moisture than is desirable in an electronics enclosure. Therefore, in an exemplary embodiment, inclusion of a desiccant system inside the enclosure is desirable and can serve two purposes. A primary purpose is to absorb any moisture that may ingress over the life of the device, but, if sized appropriately, the desiccant system will also serve to absorb any moisture that is trapped during assembly. Use of the desiccant system, therefore, simplifies assembly and eliminates the need to close the enclosure under any special environments.

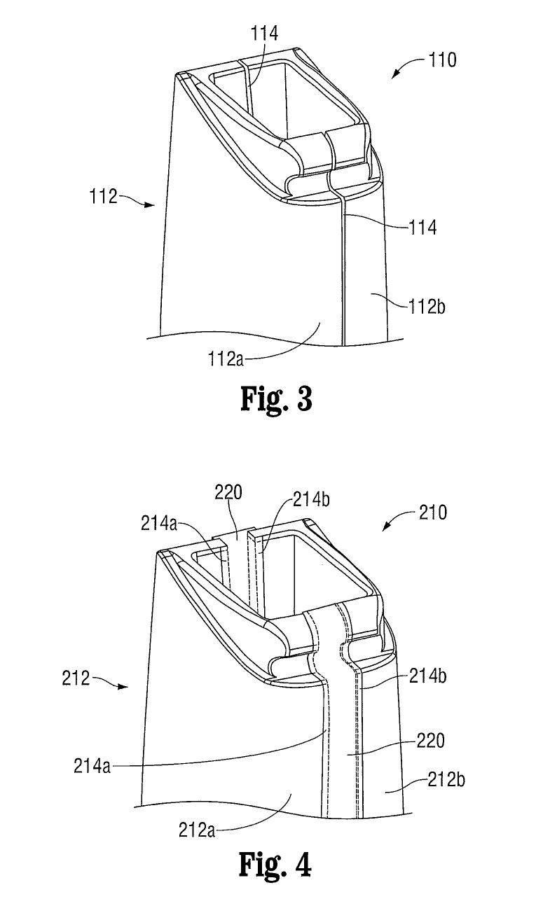

Described now are exemplary embodiments of the present invention. Referring to FIG. 3, an exemplary battery assembly 110 is provided. The battery assembly 110 includes an outer shell or housing 112 comprising a first portion 112a and a second portion 112b. In this exemplary embodiment, the first and second portions 112a and 112b are first and second halves of the outer shell or housing 112. However, there is no requirement that the housing 112 be provided in two halves. In fact, the housing 112 may be comprised of more than two sub-parts of differing portions. The first and second housing portions 112a and 112b are attached together to enclose therein mechanical and electrical components (not shown) that allow the device, to which the battery assembly 110 supplies power, to function. An ultraviolet (UV) light-curable or visible-light curable adhesive is used to attach the housing portions 112a, 112b together. In this exemplary embodiment, the first and second housing portions 112a, 112b have a contact surface 114 therebetween and the adhesive is applied at one or both opposing sides of the contact surface 114 to provide a hermetic seal between first and second housing portions 112a and 112b. Given the location of the adhesive, the adhesive is not easily depicted in the drawings and, therefore, it is not shown. However, one of ordinary skill in the art would appreciate that the adhesive is disposed between the first and second housing portions 112a and 112b along the contact surface 114 therebetween.

In this exemplary configuration, each of the first and second housing portions 112a and 112b is formed from a material that appears opaque to the naked eye, but is light transparent. In other words, the housing 112 is transmissive to light to allow for curing of the adhesive to seal the two housing portions 112a, 112b together, but it is not transmissive enough to allow visibility by the naked eye therethrough. For purposes of the present application and the claims set forth below, the terms “substantially opaque” and “substantially transparent” are respectively defined as characterizing a material that appears opaque to the naked eye, and yet, allows at least a portion of the light spectrum to be transmitted therethrough. Thus, in this exemplary embodiment, UV light (having a wavelength between about 320 and about 390 nm) or visible light (having a wavelength between about 435 and about 500 nm) is transmitted through the housing portions 112a, 112b in order to cure the adhesive and seal the housing portions 112a, 112b together.

FIG. 4 illustrates another exemplary battery assembly 210, which is similar to the battery assembly 110 of FIG. 3 and, therefore, similar reference numbers increased by 100 refer to similar parts. The battery assembly 210, however, includes a spacer band 220 disposed between the first and second housing portions 212a and 212b. A light-curable adhesive is used to attach the housing portions 212a, 212b and the band 220 together. In this exemplary embodiment, the first housing portion 212a and the band 220 have a contact surface 214a therebetween, and the second housing portion 212b and the band 220 have a contact surface 214b therebetween. The adhesive is applied at the contact surfaces 214a, 214b to provide a hermetic seal between the three parts 212a, 212b, 220 to collectively form the housing 212 in FIG. 4. Given the location of the adhesive, it is not easily depicted in the drawings and, therefore, is not shown. However, one of ordinary skill in the art would appreciate that the adhesive is disposed between the first and second housing portions 212a and 212b and the band 220 along the contact surfaces 214a, 214b therebetween.

In this exemplary configuration, the band 220 is formed from a material that is light transparent to allow for curing of the adhesive to seal the two housing portions 212a, 212b and the band 220 together. The material may be the same as that used to make the housing portions 112a, 112b of FIG. 3, i.e., visibly opaque but transmissive to light. Alternatively, since the band 220 makes up a much smaller portion of the housing 212 relative to the first and second portions 212a, 212b, the band 220 may be formed of a material that is both light transparent and visibly transparent. In such configuration, most of the components enclosed within the interior of the housing 212 would remain substantially concealed by the housing portions 212a, 212b.

The housing portions 212a, 212b of FIG. 4 may or may not be formed of the same material as the housing portions 112a, 112b in FIG. 3. In other words, it is not necessary for the housing portions 212a, 212b to be light transparent in this exemplary embodiment because light is already able to transmit through the band 220 to cure the adhesive. Thus, in the exemplary configuration of FIG. 4, UV light (having a wavelength between about 320 and about 390 nm) or visible light (having a wavelength between about 435 and about 500 nm) is transmitted through the transmissive band 220 to cure the adhesive and seal the housing portions 212a, 212b together, but the housing portions 212a, 212b need not be transparent to this light. Fillers for modifying properties of the housing portions, e.g., lubricity, stiffness, flame rating, RF blocking, can be used to create the opacity.

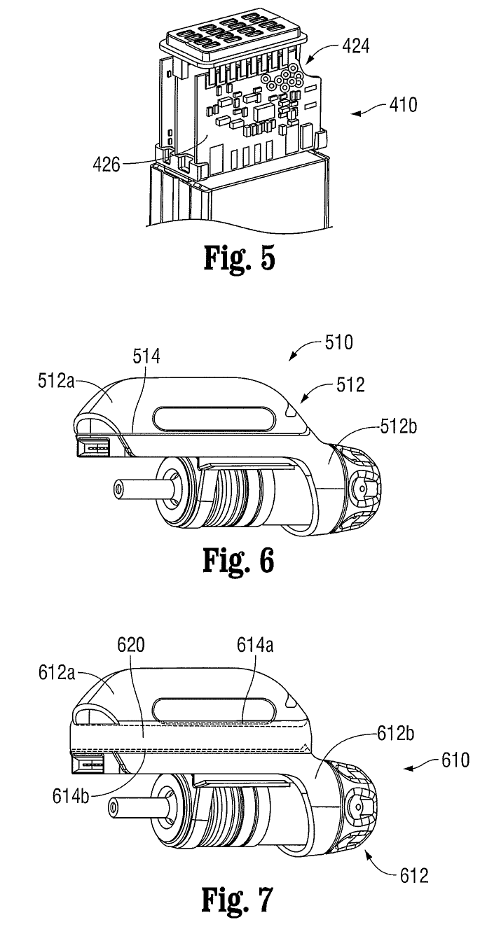

FIG. 5 illustrates an exemplary configuration of internal components of a battery assembly 410. In this exemplary embodiment, the housing is not shown but may be similar to either of the housings 112, 212 in FIG. 3 or 4. The material from which the housing is made is not relevant for purposes of curing the adhesive, whether it be visibly opaque, but transmissive to light, or entirely non-transmissive to light in this exemplary embodiment. This is because the light curable adhesive, in this exemplary configuration, is cured from the inside of the housing to provide a hermetic seal between the housing portions. For example, a plurality of light emitting diodes (LEDs) 424, may be disposed on one or more of the circuit boards 426 housed within the interior of the housing. Such LEDs are operable to transmit UV light (with a wavelength between about 320 and about 390 nm) or visible light (with a wavelength between about 435 and about 500 nm) sufficient to cure the adhesive and seal the housing portions together. The curing, i.e., operation of the LEDs, may occur, for example, during the manufacturing process. In an exemplary configuration, the LEDs can be disposed around an edge of the circuit board to illuminate evenly across the entire joint. When cured during the manufacturing process, the manufacturer is able to test the viability of the seal prior to shipment of the manufactured device.

Referring now to FIGS. 6 and 7, additional embodiments depicting exemplary sealed devices and exemplary sealing methods are shown, this time using a transducer-and-generator (“TAG”) assembly similar to the TAG assembly 303 within the device shown in FIG. 1. The exemplary embodiment of the TAG assembly 510 in FIG. 6 has a two-part housing 512, including first and second housing portions 512a, 512b, attached together to enclose therein mechanical and electrical components (not shown). A UV or visible light-curable adhesive is used to attach the housing portions 512a, 512b together. In this exemplary embodiment, the first and second housing portions 512a, 512b have a contact surface 514 therebetween, and the adhesive is applied at the contact surface 514 to provide a hermetic seal between the first and second housing portions 512a, 512b. Given the location of the adhesive, it is not easily depicted in the drawings and is, therefore, not shown. However, one of ordinary skill in the art would appreciate that the adhesive is disposed between the first and second housing portions 512a and 512b along at least one half of the contact surface 514 therebetween.

In this exemplary embodiment, each of the first and second housing portions 512a, 512b is formed from a material that appears opaque, but is light transparent. In other words, at least a portion of the housing 512 is transmissive to light to allow for curing of the adhesive to seal the two housing portions 512a, 512b together, but it is not transmissive enough to allow visibility therethrough. Thus, in this exemplary embodiment, UV light (having a wavelength between about 320 and about 390 nm) or visible light (having a wavelength between about 435 and about 500 nm) is transmitted through the housing portions 512a, 512b to cure the adhesive and seal the housing portions 512a, 512b together.

In FIG. 7, the TAG assembly 610 is similar to the TAG assembly 510 of FIG. 6, wherein similar reference numbers increased by 100 refer to similar parts. The TAG assembly 610 includes a spacer band 620 disposed between the first and second housing portions 612a and 612b. A light-curable adhesive is used to attach the housing portions 612a, 612b and the band 620 together. In this exemplary embodiment, the first housing portion 612a and the band 620 have a contact surface 614a therebetween, and the second housing portion 612b and the band 620 have a contact surface 614b therebetween. The adhesive is applied at the contact surfaces 614a, 614b to provide a hermetic seal between the three parts 612a, 612b, 620 to collectively form the housing 612 in FIG. 7. Given the location of the adhesive, it is not easily depicted in the drawings and is, therefore, not shown. However, one of ordinary skill in the art would appreciate that the adhesive is disposed between the first and second housing portions 612a and 612b and the band 620 along the contact surfaces 614a, 614b therebetween.

In this exemplary configuration, the band 620 is formed from a material that is light transparent to allow for curing of the adhesive to seal the two housing portions 612a, 612b and the band 620 together. The material may be the same as that used to make the housing portions 512a, 512b of FIG. 6, i.e., visibly opaque but transmissive to light. Alternatively, since the band 620 makes up a much smaller portion of the housing 612 relative to the first and second portions 612a, 612b, the band 620 may be formed of a material that is both light transparent and visibly transparent. In such configuration, most of the components enclosed within the interior of the housing 612 would remain substantially concealed by the housing portions 612a, 612b.

The housing portions 612a, 612b of FIG. 7 may or may not be formed of the same material as the housing portions 512a, 512b in FIG. 6. In other words, it is not necessary for the housing portions 612a, 612b to be light transparent in this exemplary embodiment because light is already able to transmit through the band 620 to cure the adhesive. Thus, in the exemplary configuration of FIG. 7, UV light (having a wavelength between about 320 and about 390 nm) or visible light (having a wavelength between about 435 and about 500 nm) is transmitted through the transmissive band 620 to cure the adhesive and seal the housing portions 612a, 612b together.

In another exemplary embodiment, a TAG assembly may include a two-part housing that is sealed by a light-curable adhesive that is cured from within the housing. For example, the housing may include one or more circuit boards enclosed therein with one or more UV LEDs disposed thereon and operable to transmit UV light (with a wavelength between about 320 and about 390 nm) or visible light (a wavelength between about 435 and about 500 nm) sufficient to cure the adhesive and provide a hermetic seal between the housing sub-parts. In this exemplary configuration, the material from which the housing is made is not relevant for purposes of curing the adhesive, whether it be visibly opaque but transmissive to light or entirely non-transmissive to light.

It is noted that the above variations in the battery assemblies can be equally applied to the TAG assembly and, therefore, they are repeated in their entirety herein.

To make any of the housing portions 112a, 112b, 212a, 212b, 512a, 512b, 612a, 612b, 2802a, 2802b substantially opaque as described herein, colorants can be used to block visible light but allow UV light to pass.

In one exemplary embodiment, where the housings 112, 212, 512, 612, 2802 and bands 220, 620 are light transmissive, but appear opaque to the naked eye, the material from which the housing portions 112a, 112b, 212a, 212b, 512a, 512b, 612a, 612b, 2802a, 2802b and bands 220, 620 are formed includes a transparent polymer, e.g., polycarbonate, polysulfone, acrylic, polyethylene terephthalate (PET), or transparent nylons. Tinting agents, diffusing agents, or other filler materials, e.g., any combination of glass, minerals, mica, and talc, are added to the transparent polymer to create a cloudy opaque appearance, yet maintain the ability to transmit UV or visible light therethrough. Diffusing agents added to the polymer material may also serve as a light guide to help disperse the light during curing of the light-curable adhesive.

For example, in accordance with the principles of the present invention, housing portions 112a, 112b, 212a, 212b, 512a, 512b, 612a, 612b, 2802a, 2802b and bands 220, 620 may be comprised of a transparent polycarbonate material that has been subsequently tinted with a tint based on a particular PANTONE® color number. In addition, a diffusing agent having Carbon Black among its constituents could be subsequently added to the polycarbonate base material.

The light-curable adhesive is a UV or visible light curable adhesive, e.g., DYMAX®, LOCTITE®, or any other suitable light-curable adhesive known by one of ordinary skill in the art. The light-curable adhesive provides advantages over other adhesives, e.g., two-part epoxy/urethane adhesives, which release free gases that corrode or degrade the polymer of the housing or circuits contained therein. This is especially advantageous for battery assemblies, in which outgassing from an epoxy adhesive, for example, cannot truly be evacuated because subjecting the battery cells to vacuum—to evacuate the outgases from within the battery assembly housing—can degrade or destroy the battery cells.

In an exemplary embodiment, the band 220, 620 includes texturizing or lensing (e.g., Fresnel shaping) on an interior surface thereof, which helps reflect the light in all directions within the battery assembly 210 or TAG assembly 610.

In another exemplary embodiment, the band 220, 620 includes tongues configured to mate with corresponding grooves formed in the first and second housing portions 212a, 612a and 212b, 612b (i.e., tongue-in-groove connections) to secure the band 220, 620 to the first and second housing portions. In such another exemplary embodiment, the groove edges and/or the tongue (configured to be disposed in the grooves), or any of the housing interior surfaces, can be selectively transparent and/or mirrored so that the curing light reflects and bounces around inside the groove or the housing to enhance curing.

In another exemplary embodiment, the adhesive effect is improved by using an inert cover gas that does not react with the photoinitiators in the adhesive. For example, the curing may occur in a nitrogen gas environment containing as little oxygen as possible.

In another exemplary embodiment, a manufacturing process uses narrow-band light filters to block curing wavelengths of light, but allows non-reactive visible wavelengths of light, in order to inspect parts that are about to be cured.

In yet another exemplary embodiment, a lower intensity reactive visible light may be used to cause a slower cure through a thicker section allowing adhesion at the surface between the adhesive and the substrate before shrinkage of the adhesive can cause delamination from the substrate.

If the interior surfaces of the housing parts are painted, and the area of the joint is outside of the opaque, painted boundary, then the outside area can be exposed to UV light for curing.

The foregoing description and accompanying drawings illustrate the principles, exemplary embodiments, and modes of operation of the invention. However, the invention shall not be construed as being limited to the particular embodiments discussed above. Additional variations of the embodiments discussed above will be appreciated by those skilled in the art and the above-described embodiments shall be regarded as illustrative rather than restrictive. Accordingly, it shall be appreciated that variations to those embodiments can be made by those skilled in the art without departing from the scope of the invention as defined by the following claims.

What is claimed is:

1. A method for creating a seal, comprising:
providing a structure comprised of at least two adjacent parts forming an enclosure and having a contact surface therebetween, at least one part of the structure being comprised of a material that appears substantially opaque to the naked eye and is substantially transparent to light;
applying a light-curable adhesive at the contact surface; and
transmitting light to cure the light-curable adhesive to form a hermetic seal at the contact surface between the at least two adjacent parts.

2. The method according to claim 1, wherein the light cures the light-curable adhesive by being transmitted through the at least one part of the structure that is both substantially opaque to the naked eye and substantially transparent to light.

3. The method according to claim 1, wherein:
the at least one part of the structure that is both substantially opaque to the naked eye and substantially transparent to light is transparent to ultraviolet light;
the light-curable adhesive is curable by ultraviolet light; and
the transmitted light is ultraviolet light.

4. The method according to claim 1, wherein:
the at least one part of the structure that is both substantially opaque to the naked eye and substantially transparent to light is transparent to visible light;
the light-curable adhesive is curable by visible light; and
the transmitted light is visible light.

5. The method according to claim 1, wherein the at least one part of the structure that is both substantially opaque to the naked eye and substantially transparent to light is comprised of a transparent polymeric material.

6. The method according to claim 5, further comprising adding at least one of:
a light-transmissive agent to the transparent polymeric material to cause the transparent polymeric material to have an opaque appearance to the naked eye; and
a diffusing agent to the transparent polymeric material to disperse the transmitted light along the contact surface for curing the light-curable adhesive.

7. The method according to claim 1, which comprises, after the applying step and before the transmitting step, forming a closed enclosure by placing the at least two adjacent parts of the structure together at the contact surface.

8. The method according to claim 1, wherein the structure further comprises a band comprised of a material that is substantially transparent to light, the band being disposed between the at least two adjacent parts at the contact surface to form the enclosure together with the at least two adjacent parts.

9. A method for creating a seal, comprising:
providing a structure comprised of:
at least first and second housing portions having first and second contact surfaces, respectively; and
a band comprised of a material that is substantially transparent to light, the band being disposed between the first and second housing portions at the first and second contact surfaces to form an enclosure together with the first and second housing portions;
applying a light-curable adhesive at the first and second contact surfaces between the band and the first and second housing portions; and
transmitting light to cure the light-curable adhesive to form a hermetic seal at the first and second contact surfaces between the band and the first and second housing portions.

10. The method according to claim 9, wherein the light cures the light-curable adhesive by being transmitted through the band.

11. The method according to claim 9, wherein:
the band is transparent to ultraviolet light;
the light-curable adhesive is curable by ultraviolet light; and
the transmitted light is ultraviolet light.

12. The method according to claim 9, wherein:
the band is transparent to visible light;
the light-curable adhesive is curable by visible light; and
the transmitted light is visible light.

13. The method according to claim 9, wherein the band appears substantially opaque to the naked eye.

14. The method according to claim 13, further comprising adding a light-transmissive agent to the band to cause it to have an opaque appearance to the naked eye.

15. The method according to claim 9, further comprising adding a diffusing agent to the band to disperse the transmitted light along at least the first and second contact surfaces for curing the light-curable adhesive.

16. A method for creating a seal, comprising:
providing a multi-part structure comprised of adjacent parts that form an enclosure and have a contact surface therebetween;
disposing at least one light source inside the enclosure;
applying a light-curable adhesive at the contact surface; and
powering the at least one light source to transmit light sufficient to cure the light-curable adhesive from inside the enclosure and, thereby, form a hermetic seal at the contact surface between the adjacent parts.

17. The method according to claim 16, further comprising:
providing a battery assembly inside the enclosure; and
electrically coupling the battery assembly to the at least one light source for powering the at least one light source.

18. The method according to claim 16, further comprising:
providing a circuit board within the enclosure; and
disposing the at least one light source on the circuit board, the circuit board being operable to cause the at least one light source to transmit light sufficient to cure the light-curable adhesive.

19. The method according to claim 16, wherein:
the at least one light source is at least one ultraviolet light source; and
the light-curable adhesive is curable by ultraviolet light.

20. The method according to claim 19, wherein the at least one light source is a plurality of ultraviolet light-emitting diodes.

21. The method according to claim 16, wherein:
the at least one light source is at least one visible light source; and
the light-curable adhesive is curable by visible light.
